(19) United States
(12) Patent Application Publication
(10) Pub. No.: US 2020/0379760 A1
(43) Pub. Date: Dec. 3, 2020

(54) LOAD INSTRUCTION WITH TIMEOUT

(71) Applicant: International Business Machines Corporation, Armonk, NY (US)

(72) Inventors: Christian Jacobi, West Park, NY (US); Matthias Klein, Poughkeepsie, NY (US); Martin Recktenwald, Schoenaich (DE); Anthony Saporito, Highland, NY (US); Robert J. Sonnelitter, III, Mount Vernon, NY (US)

(21) Appl. No.: 16/423,713

(22) Filed: May 28, 2019

(51) Int. Cl. G06F 9/30; G06F 12/0815

(52) U.S. Cl. CPC G06F 9/30043; G06F 2212/1041; G06F 9/30021; G06F 12/0815

(57) ABSTRACT

In one example implementation according to aspects of the present disclosure, a computer-implemented method for executing a load instruction with a timeout includes receiving, by a processing device, the load instruction. The method further includes attempting, by the processing device, to load a lock on a cache line of a memory. The method further includes determining, by the processing device, whether the timeout has expired prior to a successful loading of the lock on the cache line. The method further includes , responsive to determining that the timeout has expired, executing, by the processing device, another instruction instead of loading the lock on the cache line.

### BACKGROUND

The present invention generally relates to computer processing systems, and more specifically, to a load instruction with timeout.

Reduced instruction set computers (RISC) often implement load-store architectures. An example of a RISC is IBM'S PowerPC, which uses a load-store architecture. A load-store architecture uses two categories of instructions: memory access and arithmetic logic unit (ALU) operations. Memory access instructions load and store data between memory and registers. Load and store instructions are executed, for example, by a load-store unit (LSU).

### SUMMARY

Embodiments of the present invention are directed to a computer-implemented method for executing a load instruction with a timeout. A non-limiting example of the computer-implemented method includes receiving, by a processing device, the load instruction. The method further includes attempting, by the processing device, to load a lock on a cache line of a memory. The method further includes determining, by the processing device, whether the timeout has expired prior to a successful loading of the lock on the cache line. The method further includes , responsive to determining that the timeout has expired, executing, by the processing device, another instruction instead of loading the lock on the cache line.

Embodiments of the present invention are directed to a system. A non-limiting example of the system includes a memory comprising computer readable instructions and a processing device for executing the computer readable instructions for performing a method for executing a load instruction with a timeout. A non-limiting example of the method includes receiving, by a processing device, the load instruction. The method further includes attempting, by the processing device, to load a lock on a cache line of a memory. The method further includes determining, by the processing device, whether the timeout has expired prior to a successful loading of the lock on the cache line. The method further includes , responsive to determining that the timeout has expired, executing, by the processing device, another instruction instead of loading the lock on the cache line.

Embodiments of the invention are directed to a computer program product. A non-limiting example of the computer program product includes a computer readable storage medium having program instructions embodied therewith. The program instructions are executable by a processor to cause the processor to perform a method for executing a load instruction with a timeout. A non-limiting example of the method includes receiving, by a processing device, the load instruction. The method further includes attempting, by the processing device, to load a lock on a cache line of a memory. The method further includes determining, by the processing device, whether the timeout has expired prior to a successful loading of the lock on the cache line. The method further includes , responsive to determining that the timeout has expired, executing, by the processing device, another instruction instead of loading the lock on the cache line.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the presently described techniques according to one or more embodiments described herein;

FIG. 4 depicts a block diagram of a processing system for executing a load instruction with timeout according to one or more embodiments described herein;

FIG. 5 depicts a flow diagram of a method for executing a load instruction without a timeout according to one or more embodiments described herein;

FIG. 6 depicts a flow diagram of a method for executing a load instruction with a timeout according to one or more embodiments described herein; and

FIG. 7 depicts a flow diagram of a method for executing a load instruction with a timeout according to one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

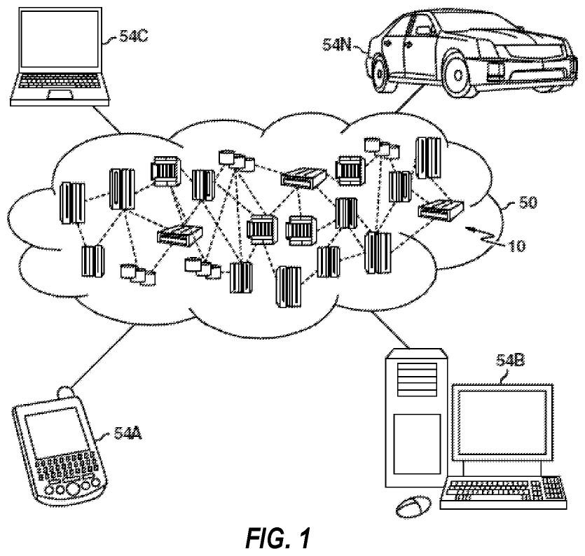

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

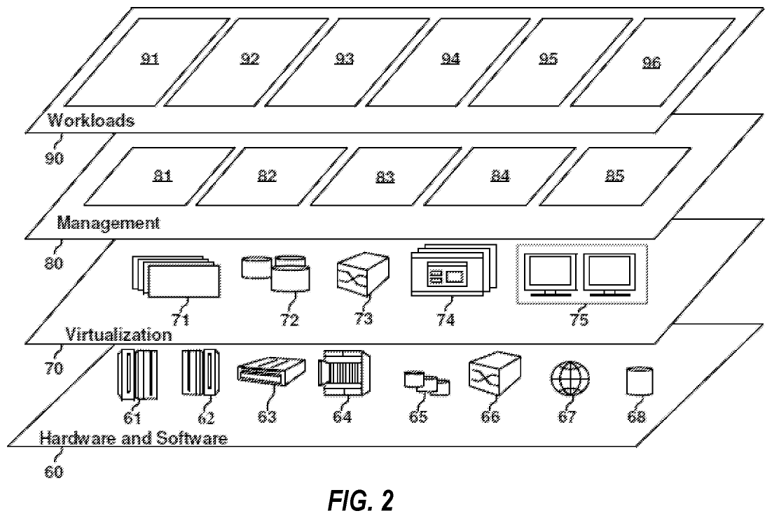

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and load instruction with timeout 96.

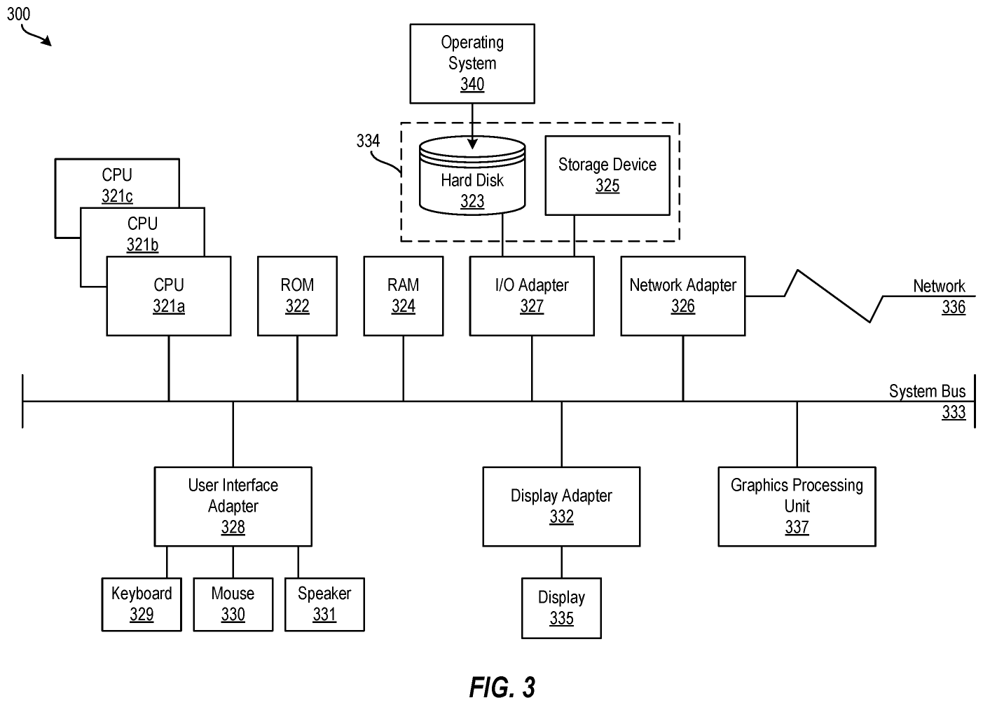

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a storage device 325 or any other similar component. I/O adapter 327, hard disk 323, and storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adapter 332, which may include a graphics adapter to improve the performance of graphics intensive applications and a video controller. In one aspect of the present disclosure, adapters 326, 327, and/or 332 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store the operating system 340 such as the AIX® operating system from IBM Corporation to coordinate the functions of the various components shown in processing system 300.

Turning now to an overview of technologies that are more specifically relevant to aspects of the invention, an instruction referred to as “load with timeout” or “load instruction with timeout” is provided. In some load-store architectures, such as IBM's z architecture, a lock “stiff arming” technique using next instruction access intent code points to indicate lock-acquiring instructions. The processor (e.g., CPU) on successful lock-acquire rejects cross-invalidation requests to the cache line until the lock is released. A lock-acquire grants access to a cache line to the processor (or core) and excludes other processors (or cores) from accessing the cache line. This prevents other processors from dragging the cache line through the nest uselessly since these processors only see that the lock is busy. However, the stiff arming technique also prevents other processors from observing that the lock is busy. In some cases, it is beneficial to know that the lock is busy and then, instead of waiting for it to become free, the processors go to some other program logic to perform other tasks in the meantime.

The present techniques provide improve processor efficiency (i.e., computer functionality) by reducing waiting time by implementing a timeout with load instructions. When a standard load instruction is issued and misses the cache, a timeout counter begins. In examples, a timeout period for the timeout counter is set to 100 cycles, 500 cycles, 1000 cycles, 1500 cycles, 2000 cycles, 3000 cycles, 5000 cycles, etc. Once the timeout is reached (i.e., upon expiration of the timeout), the processor issuing the load instruction does not wait any further for the cached data to arrive. Instead, the processor leaves the target register unmodified (or set to 0) and indicates in a condition code that the load was not successful. This is an indication to the program that it is likely another processor is “stiff arming” the cache line, and accordingly, this allows the processor to move to other work.

In some examples, since the delay could be caused by other effects, after multiple attempts at issuing the load instruction, the processor performs a true “load” instruction to validate that the lock is really busy and then decides either to wait for it to become free or keep working on other tasks while it is locked. In another example, the load instruction with timeout is provided to firmware or software with certain privileges to avoid potential cover channels.

Turning now to an overview of the aspects of the invention, one or more embodiments of the invention address the above-described shortcomings of the prior art by providing a load instruction with timeout. An example of a method for executing a load instruction with a timeout includes receiving the load instructions and attempting to load a lock on a cache line of a memory. It is then determined whether the timeout period has expired prior to a successful loading of the lock on the cache line. If it determined that the timeout period has expired, the processing device executes another instruction instead of loading the lock on the cache line. This improves processor efficiency (i.e., computer functionality) by reducing waiting time by implementing a timeout with load instructions. In examples, the “load with timeout” can be generalized for any memory location and does not have to be a lock.

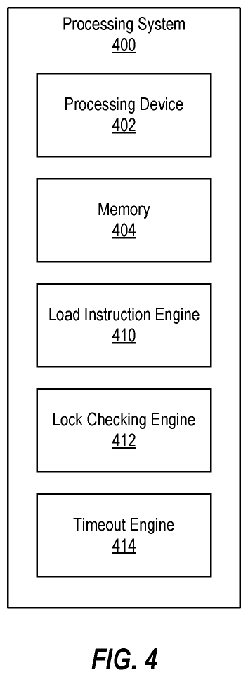

FIG. 4 depicts a block diagram of a processing system 400 for executing a load instruction with timeout according to one or more embodiments described herein. The various components, modules, engines, etc. described regarding FIG. 4 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming The programming can be processor executable instructions stored on a tangible memory, and the hardware can include the processing device 402 for executing those instructions. Thus a system memory (e.g., memory 404) can store program instructions that when executed by the processing device 402 implement the engines described herein. Other engines can also be utilized to include other features and functionality described in other examples herein.

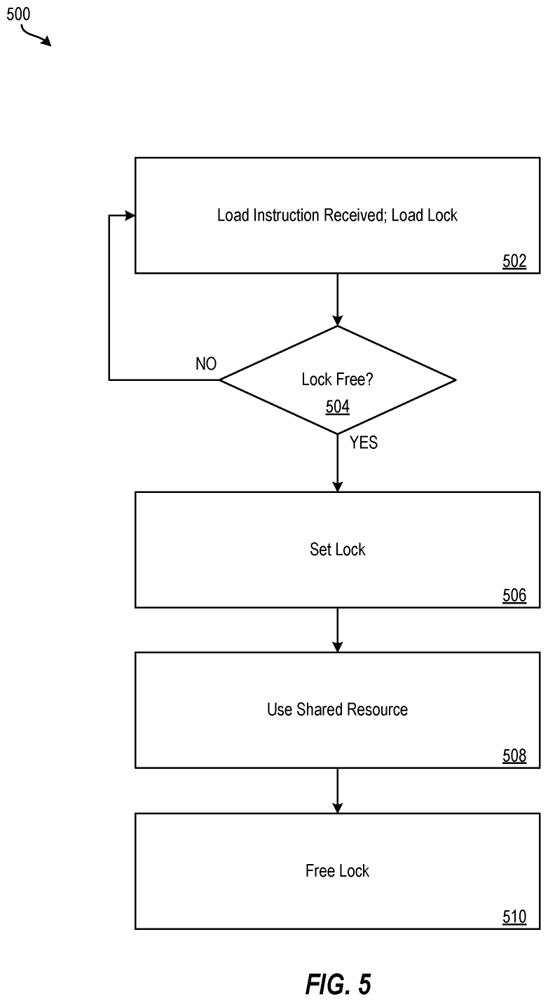

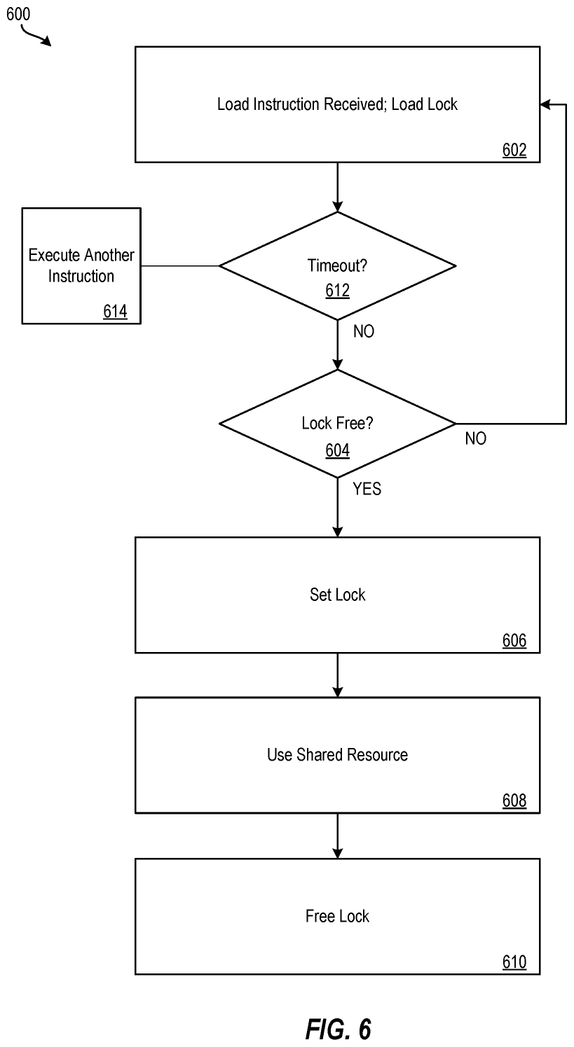

The processing system 400 includes a load instruction engine 410 that receives and executes load instructions, a lock checking engine 412 to check to see if a lock on a cache line is free, and a timeout engine 414 to determine whether a timeout period has expired. The features and functionality of the load instruction engine 410, the lock checking engine 412, and the timeout engine 414 are described in more detail with reference to FIGS. 5 and 6.

FIG. 5 depicts a flow diagram of a method 500 for executing a load instruction without a timeout according to one or more embodiments described herein. The method 500 is performed by any suitable processing system (e.g., the cloud computing environment 50, the processing system 300, the processing system 400, etc.), processing device (e.g., the CPU 321, the processing device 402, etc.), and/or combinations thereof.

At block 502, the load instruction engine 410 receives the load instruction and attempts to load the lock on a cache line of a memory. This can be performed using a compare and swap operation. A compare and swap operation compares a first operand to a second operand. If the two operands are equal, a third operand is stored at the second operand location. However, if the two operands are unequal, the second operand is loaded into the first operand location, and the result of the comparison is indicated in a condition code.

The lock is a storage location within the memory 404 (or another suitable memory). As such, to load it, the cache line has to be fetched into the local processor core of the processing device 402. At decision block 504, the lock checking engine 412 checks to see if the lock is free. If the lock is not free at decision block 504, the method 500 returns to block 502. If, however, the lock is free at decision block 504, the load instruction engine 410 sets the lock at block 506.

To set the lock, the cache line has to be loaded exclusively into the local processor core. Cache coherency protocol behavior indicates that the cache line has to be invalidated in all other processor cores. However, in examples with many cores running in a loop, each core wants to fetch the lock to view its contents. The cache line keeps bouncing around between processor cores, even though just one of them can actually get the lock. Additionally, once a core has the lock, the other cores continue to try to fetch that cache line just to see if the lock is still set. This results in wasted processing cycles with cores (or processing devices) checking to see if the lock is set. This time could be used executing other instructions instead.

At block 508, the processing device 402 uses the content of the cache line (i.e., a shared resource) to execute an instruction. Once completed, the load instruction engine 410 frees the lock at block 510. The core that owns the lock has to re-fetch the cache line to free the lock, which again takes processing cycles because the other cores (or processing devices) are trying to check to see if the lock is set.

Additional processes also may be included, and it should be understood that the process depicted in FIG. 5 represents an illustration, and that other processes may be added or existing processes may be removed, modified, or rearranged without departing from the scope of the present disclosure.

In some approaches, the lock line is kept throughout a “critical section” until the lock is released. The critical section is a section of execution between setting and releasing a lock cache line. Essentially, once a core gets the cache line, other cores are not allowed to look at it until released. This can be referred to as “stiff arming.” However, during the time that the cache line is locked, the other cores essentially sit idle with nothing to do. By introducing a timeout, these processing cycles can be recaptured for performing useful work.

Turning now to FIG. 6, the wasted processing cycles described herein can be reduced/eliminated by introducing a timeout. In particular, FIG. 6 depicts a flow diagram of a method 600 for executing a load instruction without a timeout according to one or more embodiments described herein. The method 600 is performed by any suitable processing system (e.g., the cloud computing environment 50, the processing system 300, the processing system 400, etc.), processing device (e.g., the CPU 321, the processing device 402, etc.), and/or combinations thereof.

At block 602, the load instruction engine 410 receives the load instruction and attempts to load the lock on a cache line of a memory. This can be performed using a compare and swap operation. The following example pseudo-code implements the functionality performed by the load instruction engine 410:

LOAD memory location into register Rx
BRANCH ON CONDITION CODE = 1 to do_something_else
... normal lock handling as with any existing locking/critical section

code ...

do_something_else:

do something else

Due to the challenges of setting condition code, the present techniques provide for setting a fixed value. For example, if the program logic knows that the memory location cannot have a valid of 0, and the load-with-timeout instruction is defined to return the value 0 if a timeout happens, but the value of the memory location otherwise, the following example pseudo-code can be implemented:

LOAD memory location into register Rx
COMPARE register Rx vs 0 (−> this is standard instruction that sets the

condition code)

BRANCH ON CONDITION CODE set to “compare successful” to

do_something_else

The method 600 introduces a timeout determination at decision block 612. In particular, at decision block 612, the timeout engine 414 determines whether a timeout period has expired prior to successful loading of the lock on the cache line. The timeout period can be predefined, adjustable, dynamically adjusted (e.g., based on current workloads), etc. In one example, the timeout period is approximately 2000 processing cycles, although other periods can be used. If it determined at decision block 612 that the timeout period has been exceeded, the method 600 proceeds to block 614, and the processing device 402 can execute another instruction. This enables the processing device 402 to execute other instructions (e.g., an instruction from another work queue) when the lock is busy/unavailable, thus reducing/eliminating wasted processing cycles and improving computer functionality

If at decision block 612 it is determined that the timeout is not exceeded, the method proceeds to decision block 604, and the lock checking engine 412 checks to see if the lock is free. If the lock is not free at decision block 604, the method 600 returns to block 602. If, however, the lock is free at decision block 604, the load instruction engine 410 sets the lock at block 606.

At block 608, the processing device 402 uses the content of the cache line (i.e., a shared resource) and/or another resource to execute an instruction. Once completed, the load instruction engine 410 frees the lock at block 610.

Additional processes also may be included. For example, the load instruction can return an indication to a calling program whether the timeout has expired or whether the load instruction was performed successfully. In some example, the indication can be returned as a condition code and/or as a distinct value. The distinct value can be predefined by the processing device in some examples or by the calling program in other examples. In the case of a condition code, the condition code can be used to steer program flow, for example, by being used to determine the direction taken on a subsequent branch instruction. In the case of a distinct value, the distinct value can be defined by the program using an “immediate” field in the instruction. It should be understood that the process depicted in FIG. 6 represents an illustration, and that other processes may be added or existing processes may be removed, modified, or rearranged without departing from the scope of the present disclosure.

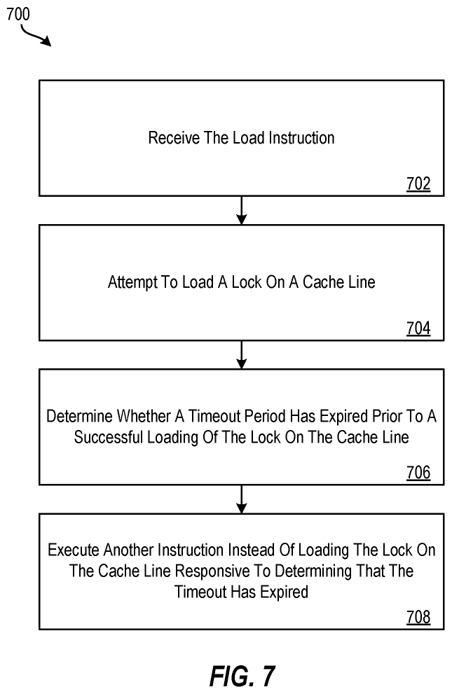

FIG. 7 depicts a flow diagram of a method 700 for executing a load instruction without a timeout according to one or more embodiments described herein. The method 700 is performed by any suitable processing system (e.g., the cloud computing environment 50, the processing system 300, the processing system 400, etc.), processing device (e.g., the CPU 321, the processing device 402, etc.), and/or combinations thereof.

At block 702, the load instruction engine 410 receives a load instruction. In examples, the load instruction is received from a work queue, which may be one of multiple work queues. The work queue(s) store work to be done by the processing device 402 and/or by other processing devices.

At block 704, the load instruction engine 410 attempts to loads a lock on a cache line of a memory (e.g., the memory 404). In examples, the memory is a shared memory shared between multiple processing devices, multiple cores of a processing device, multiple threads of a processing device, multiple treads of a core of a processing device, and combinations thereof and the like. In some examples, loading the lock on the cache line is performed using a compare and swap operation.

At block 706, the timeout engine 414 determines whether a timeout period has expired prior to successful loading of the lock on the cache line. The timeout period can be predefined, adjustable, dynamically adjusted (e.g., based on current workloads), etc. In one example, the timeout period is approximately 2000 processing cycles, although other periods can be used.

At block 708, the processing device 402 executes another instruction instead of loading the lock on the cache line responsive to determining that the timeout has expired. This enables the processing device 402 to execute other instructions (e.g., an instruction from another work queue) when the lock is busy/unavailable, thus reducing/eliminating wasted processing cycles and improving computer functionality

Additional processes also may be included. For example, responsive to determining that the timeout has not expired, the lock checking engine 412 determines whether the lock of the cache line is free. Responsive to determining that the lock is free, the load instruction engine 410 sets the lock of the cache line and, subsequent to the setting, the processing device 402 executes an instruction (such as from the work queue) using contents of the cache line. Subsequent to executing the instruction using the contents of the cache line, the processing device 202 frees the lock of the cache line.

In additional examples, responsive the lock checking engine 412 determining that the lock is not free, the processing device 402 retries loading the lock on the cache line. It should be understood that the process depicted in FIG. 7 represents an illustration, and that other processes may be added or existing processes may be removed, modified, or rearranged without departing from the scope of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for executing a load instruction with a timeout, the method comprising:
receiving, by a processing device, the load instruction;
attempting, by the processing device, to load a lock on a cache line of a memory;
determining, by the processing device, whether the timeout has expired prior to a successful loading of the lock on the cache line; and
responsive to determining that the timeout has expired, executing, by the processing device, another instruction instead of loading the lock on the cache line.

2. The method of claim 1, wherein the load instruction returns an indication to a calling program whether the timeout has expired or whether the load instruction was performed successfully.

3. The method of claim 2, wherein the indication is a condition code.

4. The method of claim 2, wherein the indication realized by returning a distinct value predefined by the processing device or defined by the calling program instead of the load data.

5. The computer-implemented method of claim 1, further comprising:
responsive to determining that the timeout has not expired, determining, by the processing device, whether the lock of the cache line is free.

6. The computer-implemented method of claim 5, further comprising:
responsive to determining that the lock is free, setting, by the processing device, the lock of the cache line; and
subsequent to setting the lock of the cache line, executing, by the processing device, an instruction using contents of the cache line.

7. The computer-implemented method of claim 6, further comprising:
subsequent to executing the instruction using the contents of the cache line, freeing, by the processing device, the lock of the cache line.

8. The computer-implemented method of claim 6, further comprising:
responsive to determining that the lock is not free, retrying, by the processing device, loading the lock on the cache line.

9. The computer-implemented method of claim 1, wherein the timeout is 2000 processing cycles.

10. The computer-implemented method of claim 1, wherein loading the lock on the cache line is performed using a compare and swap operation.

11. A system comprising:
a memory comprising computer readable instructions; and
a processing device for executing the computer readable instructions for performing a method for executing a load instruction with a timeout, the method comprising:
receiving, by the processing device, the load instruction;
attempting, by the processing device, to load a lock on a cache line of a memory;
determining, by the processing device, whether the timeout has expired prior to a successful loading of the lock on the cache line; and
responsive to determining that the timeout has expired, executing, by the processing device, another instruction instead of loading the lock on the cache line.

12. The system of claim 11, wherein the load instruction returns an indication to a calling program whether the timeout has expired or whether the load instruction was performed successfully.

13. The system of claim 12, wherein the indication is a condition code.

14. The system of claim 12, wherein the indication realized by returning a distinct value predefined by the processing device or defined by the calling program instead of the load data.

15. The system of claim 11, wherein the method further comprises:
responsive to determining that the timeout has not expired, determining, by the processing device, whether the lock of the cache line is free.

16. The system of claim 15, wherein the method further comprises:
responsive to determining that the lock is free, setting, by the processing device, the lock of the cache line; and
subsequent to setting the lock of the cache line, executing, by the processing device, an instruction using contents of the cache line.

17. The system of claim 11, wherein the method further comprises:
subsequent to executing the instruction using the contents of the cache line, freeing, by the processing device, the lock of the cache line.

18. The system of claim 11, wherein the method further comprises:
responsive to determining that the lock is not free, retrying, by the processing device, loading the lock on the cache line.

19. A computer program product comprising:
a computer readable storage medium having program instructions embodied therewith, the program instructions executable by a processing device to cause the processing device to perform a method for executing a load instruction with a timeout, the method comprising:
receiving, by the processing device, the load instruction;
attempting, by the processing device, to load a lock on a cache line of a memory;
determining, by the processing device, whether the timeout has expired prior to a successful loading of the lock on the cache line; and
responsive to determining that the timeout has expired, executing, by the processing device, another instruction instead of loading the lock on the cache line.

20. The computer program product of claim 19, wherein the load instruction returns an indication to a calling program whether the timeout has expired or whether the load instruction was performed successfully.
